(19) United States
(12) Patent Application Publication
(10) Pub. No.: US 2025/0371260 A1
(43) Pub. Date: Dec. 4, 2025

(54) DYNAMIC SHARING OF WEB-CONTENT

(71) Applicant: CITRIX SYSTEMS, INC., Fort Lauderdale, FL (US)

(72) Inventors: PENG YAO, NANJING (CN); TIANYU XIAO, NANJING (CN)

(21) Appl. No.: 18/873,794

(22) PCT Filed: Sep. 22, 2022
(86) PCT No.: PCT/CN2022/120538

§ 371 Date: Dec. 11, 2024

(51) Int. Cl. G06F 40/197; G06F 3/14; G06F 16/957; G06F 21/62; G06F 40/134; G06F 40/14

(52) U.S. Cl. CPC G06F 40/197; G06F 3/1454; G06F 16/9577; G06F 21/6218; G06F 40/134; G06F 40/14

(57) ABSTRACT

Methods and systems for presenting content are described herein. A computing device may receive, from a first client device, first data associated with a first webpage being displayed in a first web browser on the first client device. The computing device may generate, based on the first data, a read-only webpage corresponding to the first webpage. The computing device may send second data that is configured to enable rendering, in a second web browser on the second client device, the first read-only webpage, so that content in the first webpage is shared between the first client device and the second device. In this way, the content may be shared dynamically among different users.

### FIELD

Aspects described herein generally relate to content presentation, and hardware and software related thereto. More specifically, one or more aspects described herein provide systems and methods for sharing web-content.

### BACKGROUND

People may communicate with each other remotely. For example, a professor may provide an online lecture to students who are located in different places. If the professor wants to present content on a webpage while discussing a topic, the professor may open the webpage on the professor's laptop and use the screen-sharing function provided by a virtual meeting application to share the web-content. However, the content that is presented via the screen-sharing function is usually displayed as a live video. Other participants are unable to view the web-content at their own pace via the live video or copy text from the live video.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

While web-content is shared among users who communicate with each other remotely, some users may want to review the web-content at their own pace and/or make operations on the content. For example, users may want to copy the text being shared and integrate the copied text into their personal notes. In another example, users may want to review the content that was discussed previously or preview the content that may be discussed next. However, web-content presented via the screen-sharing function of a virtual meeting is usually displayed as a live video. Users may not be able to copy text from the live video or read content that is not presented at the current moment via a live video. Systems and methods that allow participants to share web-content more flexibly are needed.

To overcome limitations in the prior art described above, and to overcome other limitations that will be apparent upon reading and understanding the present specification, aspects described herein are directed towards sharing web-content via web browsers. The web-content shared by a presenter may be presented, on other participants' client devices, in a webpage format via their web browsers. The webpage format may allow the participants of a meeting to copy the text being shared. A participant may also scroll up or down to view other portions of the webpage while listening to the presenter. The presenter's input operation (e.g., pointing/highlighting a certain area of the webpage by a mouse icon) may be converted to one or more images (or videos) and overlaid to the webpage displayed on the participant's device. The webpage displayed on the participant's device may be a read-only webpage, so that the presenter does need not to worry about other participants accessing sensitive data via links on the presented webpage.

In at least one implementation, a computing device (e.g., a server) may receive, from a first client device, first data associated with a first webpage being displayed in a first web browser on the first client device. The computing device may generate, based on the first data, a read-only webpage corresponding to the first webpage, and send, to a second client device while the first webpage is displayed in the first web browser, second data that is configured to enable rendering, in a second web browser on the second client device, the read-only webpage, so that content in the first webpage is shared between the first client device and the second client device. The computing device may receive, from the first client device, an indication of an input event, on the first web browser, that occurs while the content in the first webpage is shared. The computing device may send, to the second client device, third data associated with the input event, wherein the third data is configured to enable displaying, in the second web browser, one or more images representing the input event.

In some instances, the first webpage may comprise a link to access a second webpage, and wherein the read-only webpage restricts accessing, via the link, the second webpage.

In some instances, the sending the second data may be based on a determination that a user associated with the second web browser does not have authority to access the first webpage.

In some instances, the input event may comprise a request to access a second webpage. The computing device may further receive, from the first client device, fourth data associated with the second webpage. The computing device may generate a second read-only webpage corresponding to the second webpage, and store, in a database, a mapping among the read-only webpage, the input event, and the second read-only webpage.

In some instances, the computing device may further receive, from a third client device and after the content in the first webpage is shared, a request to access the content. The computing device may send, to the third client device, the second data associated with the read-only webpage and a link to the second read-only webpage. The computing device may receive, from the third client device, a request to access, via the link, the second read-only webpage, and send, to the third client device, the second read-only webpage.

In some instances, the first data may comprise at least one of: document object model (DOM) data; cascading style sheets (CSS) data; or a uniform resource locator (URL) link.

In some instances, the generating the read-only webpage may comprise adding JavaScript (JS) data into the first data.

In some instances, the computing device and the first client device are located on the same physical device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 5C is a block diagram similar to that shown in FIG. 5B but in which the available resources are represented by a single box labeled “systems of record,” and further in which several different services are included among the resource management services.

FIG. 5D shows how a display screen may appear when an intelligent activity feed feature of a multi-resource management system, such as that shown in FIG. 5C, is employed.

FIG. 6 depicts an illustrative computing environment in accordance with one or more illustrative aspects described herein.

FIGS. 7A to 7B depict an example method for presenting content in accordance with one or more illustrative aspects described herein.

FIG. 8 depicts a flow diagram of another example method for presenting content in accordance with one or more illustrative aspects described herein.

FIG. 9 depicts an example user interface in accordance with one or more illustrative aspects described herein.

FIG. 10 depicts another example user interface in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

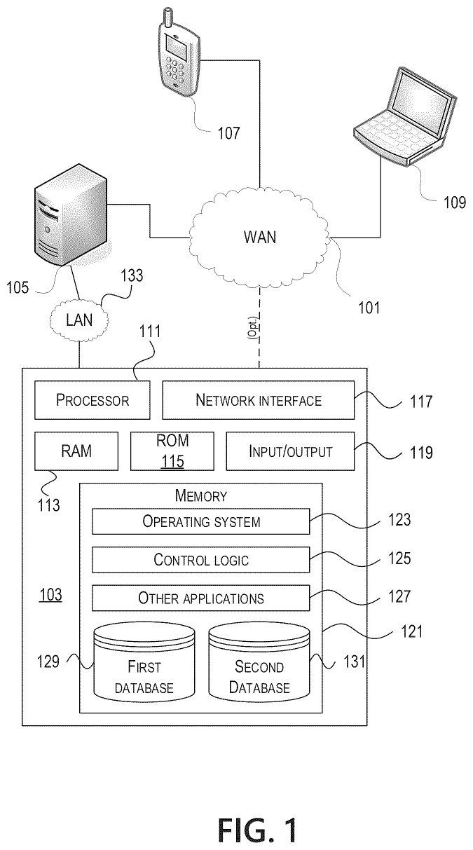

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

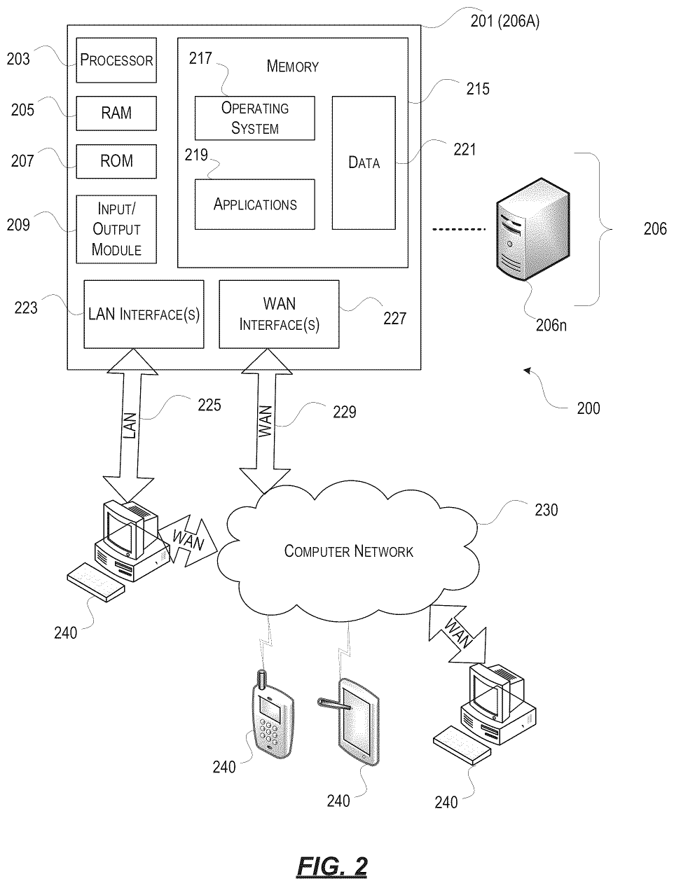

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

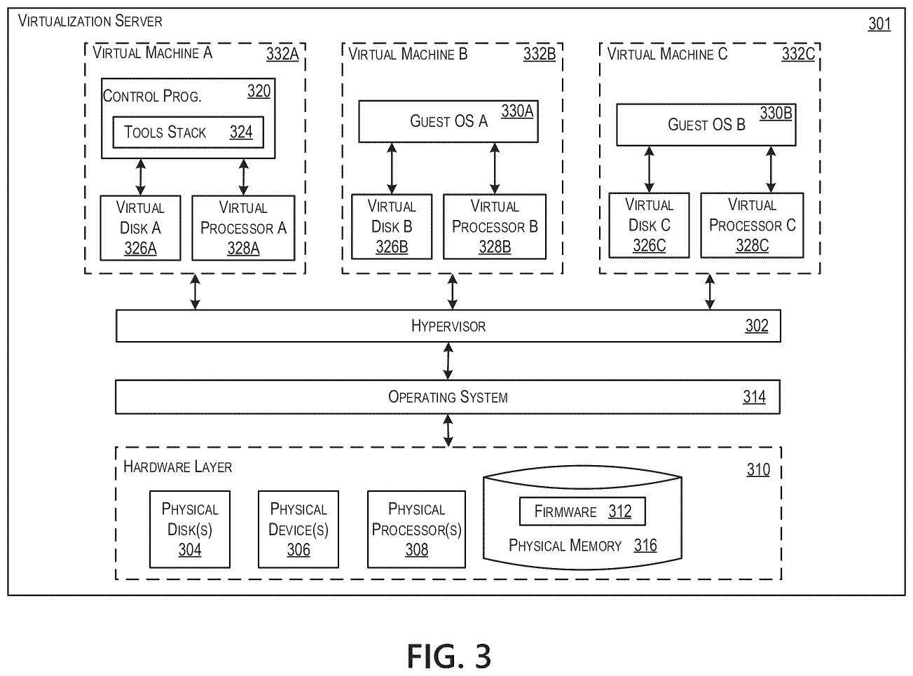

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

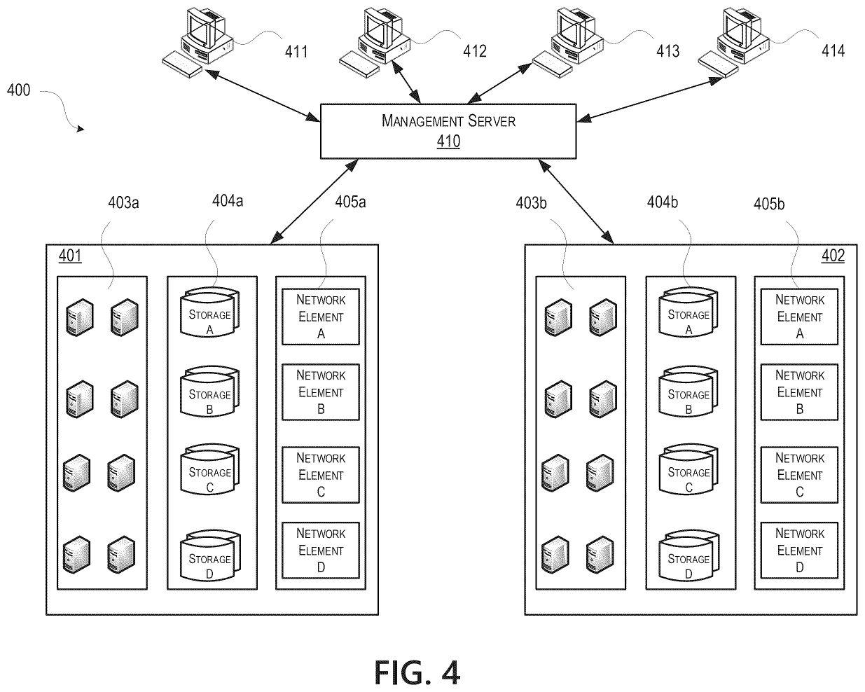

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Resource Management System

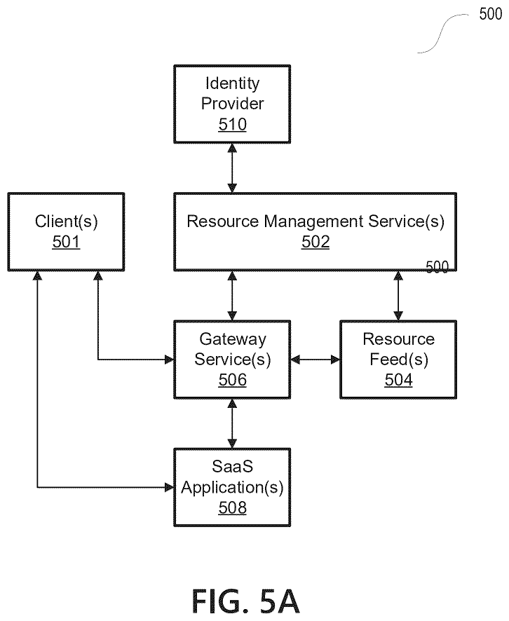

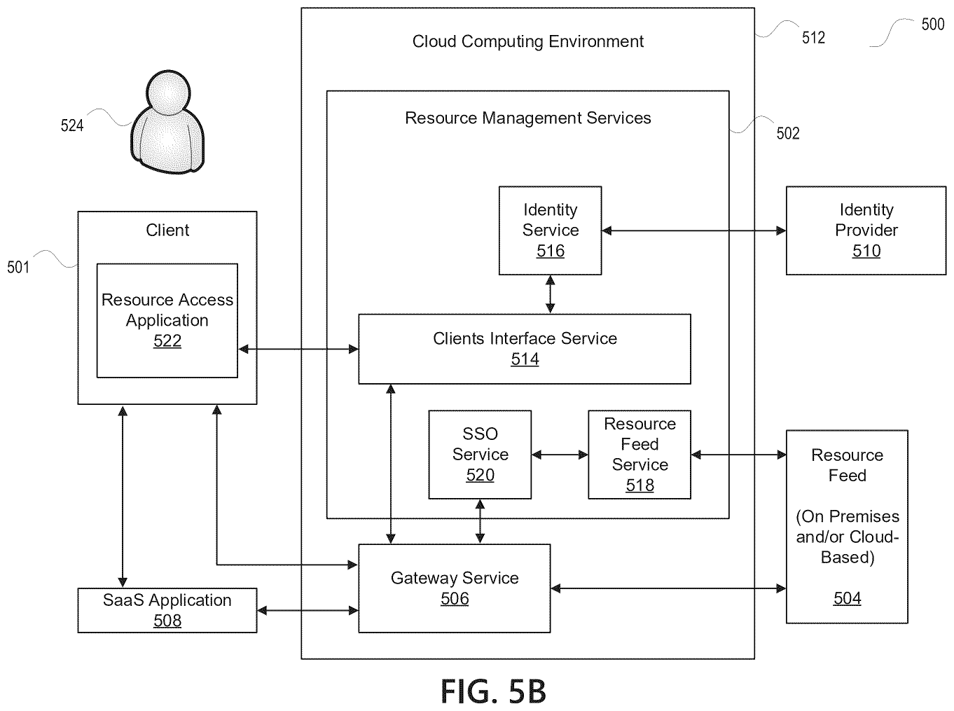

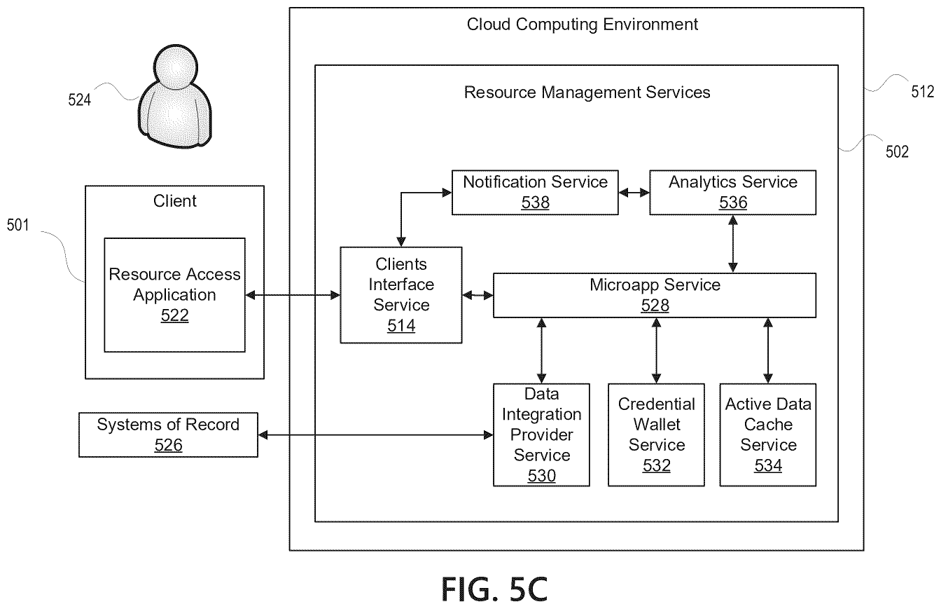

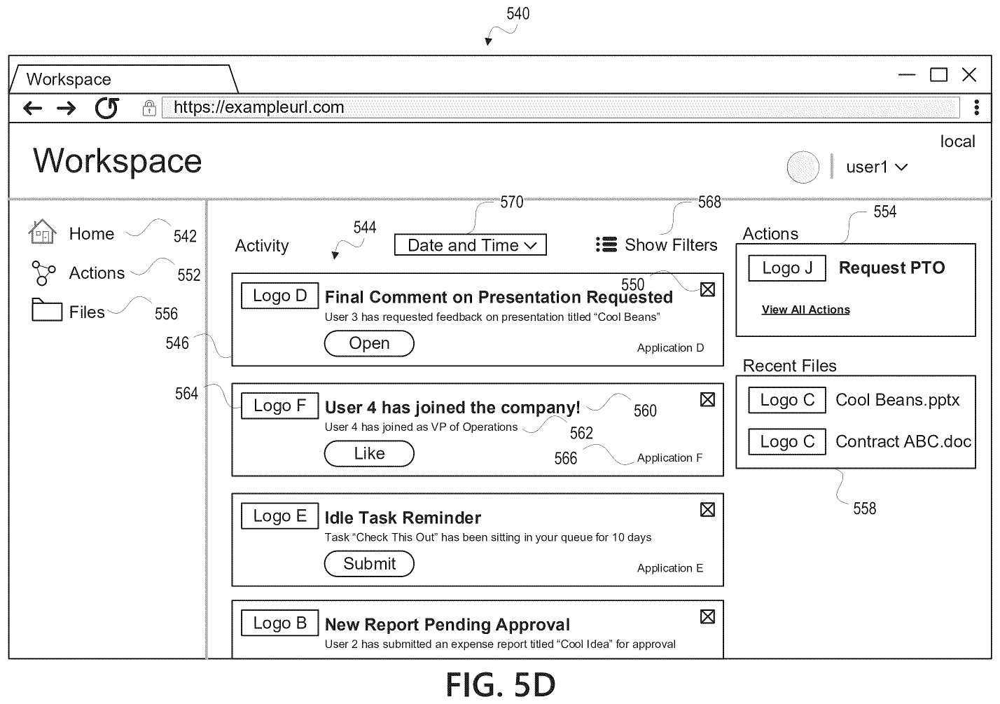

FIG. 5A is a block diagram of an example multi-resource access system 500 in which one or more resource management services 502 may manage and streamline access by one or more clients 501 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 501 and, following authentication, identify one of more resources the user is authorized to access. In response to the user selecting one of the identified resources, the resource management service(s) 502 may send appropriate access credentials to the requesting client 501, and the client 501 may then use those credentials to access the selected resource. For the resource feed(s) 504, the client 501 may use the supplied credentials to access the selected resource via a gateway service 506. For the SaaS application(s) 508, the client 501 may use the credentials to access the selected application directly.

The client(s) 501 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 501, one or more file repositories and/or file sharing systems, one or more secure browser services, one or more access control services for the SaaS applications 508, one or more management services for local applications on the client(s) 501, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B depicts a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 501) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 501 may use a resource access application 522 to communicate with the client interface service 514 as well as to present a user interface on the client 501 that a user 524 can operate to access the resource feed(s) 504 and/or the SaaS application(s) 508. The resource access application 522 may either be installed on the client 501, or may be executed by the client interface service 514 (or elsewhere in the multi-resource access system 500) and accessed using a web browser (not shown in FIG. 5B) on the client 501.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 501 to be redirected to the cloud-based identity service to complete an authentication process. The cloud-based identity service may then cause the client 501 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 501. The list of available resources may, for example, be presented on the user interface of the client 501 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 501, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 501 may proceed to access the selected resource.

When the user 524 selects a local application, the resource access application 522 may cause the selected local application to launch on the client 501. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 501 may then launch the identified browser and initiate a connection to the gateway service 506. The gateway service 506 may then request an assertion from the single sign-on service 520. Upon receiving the assertion, the gateway service 506 may cause the identified browser on the client 501 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 501 to access the selected SaaS application 508.

In some embodiments, the preferred browser identified by the gateway service 506 may be a specialized browser embedded in the resource access application 522 (when the resource access application 522 is installed on the client 501) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 501 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 501, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “decline,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 501 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 501. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically cause active data to be pulled from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 501 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 501 as a push notification to the user 524.

In some embodiments, a process for processing a user-initiated action via a microapp may operate as follows. The client 501 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce®, Ariba®, Concur®, RightSignature®, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one of more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D) and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files.

Although not shown in FIG. 5D, it should be appreciated that, in some implementations, additional resources may also be accessed through the screen 540 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops® service) by clicking on or otherwise selecting a “desktops” user-interface element (not shown) to reveal a list of accessible desktops.

The activity feed shown in FIG. 5D provides significant benefits, as it allows a user to respond to application-specific events generated by disparate systems of record without needing to navigate to, launch, and interface with multiple different native applications.

### Web-Content Sharing

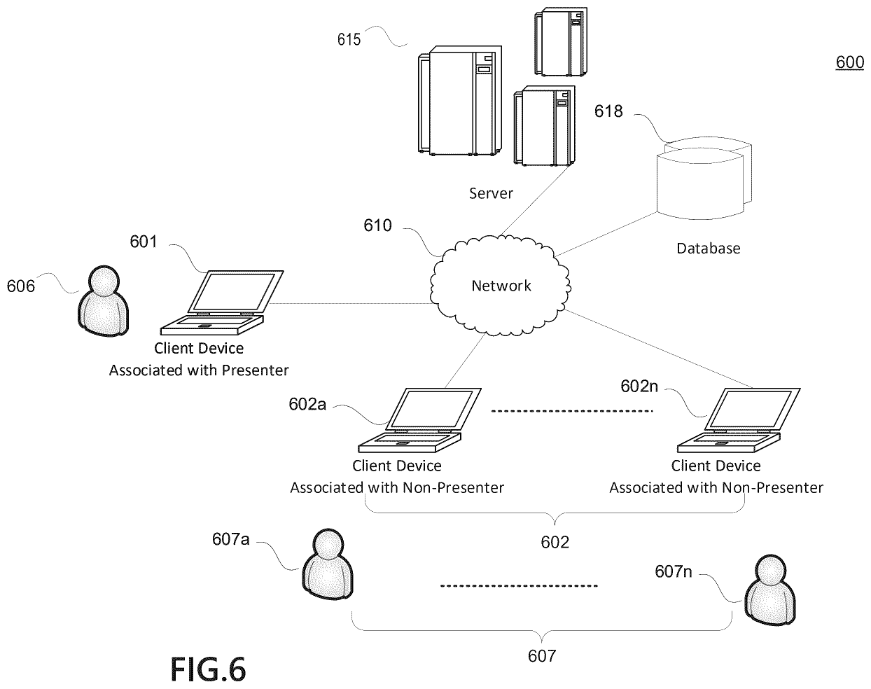

FIG. 6 depicts an illustrative computing environment 600 in accordance with one or more example embodiments. Computing environment 600 may include a plurality of client devices (e.g., client device 601, 602a-602n). A client device may be any of devices 107 or 109 (as depicted in FIG. 1), client machine 240 (as depicted in FIG. 2), a client 501 as depicted in FIGS. 5A-5D, or other computing devices. In some instances, the client device may be configured to expose or otherwise display an interface, and communicate with one or more servers (e.g., via an API) to update the interface in response to user input received at the client device. Each of the plurality of user devices may be a laptop, a tablet, or a mobile device.

A client device may be used by a user to communicate with other users remotely (e.g., by attending a virtual meeting). For convenience, although a virtual meeting is used as an example for the majority of the description. It is appreciated that the web-content sharing described herein may be applied in any kind of remote communication scenario, including but not limited to a video conference, an audio conference, or a point-to-point communication between two users.

The client device may send upstream data to facilitate the user's interaction with other participants in the virtual meeting, and/or receive downstream data that is presented by other participants. One or more users may be presenters 606 (e.g., a professor holding a lecture) of the virtual meeting. The other one or more users may be non-presenters 607a-607n (e.g., students attending the lecture) of the virtual meeting. As shown in FIG. 6, the client device 601 may be associated with (e.g., used by) a presenter 606. Each of client devices 602 (e.g., 602a-602 n) may be associated with a non-presenter 607 (e.g., 607a-607 n). A presenter 606 may be allowed to present at least a portion of the screen display to the non-presenters 607, via the client device 601. A non-presenter 607 may not be allowed to present his or her screen display. The content of the virtual meeting may be displayed on a graphical user interface (hereinafter “GUI”) on the client device. It is appreciated that during a meeting, the role of participants may change. For example, a user may be a present 606 during a first time period of the virtual meeting, and may be a non-presenter 607 during a second time period of the virtual meeting.

Server 615 may be a computer system that includes one or more computing devices and/or other computer components (e.g., processors, memories, communication interfaces, servers, server blades, or the like). For example, server 615 may be and/or include any of data server 103 or web server 105 (as depicted in FIG. 1), server 206 (as depicted in FIG. 2), virtualization server 301 (as described in FIG. 3), the management server 410 (as depicted in FIG. 4), and/or cloud computing environment 512 (as described in FIG. 5). In addition, server 615 may be configured to support a virtual meeting that may be displayed or otherwise utilized by the client devices. Database 618 may be configured to store data (e.g., webpages, links, or user profiles as described herein). Database 618 may be located on the same physical device as server 615, or may be located separately from server 615.

Computing environment 600 may also include one or more networks, which may interconnect client devices (601 and/or 602), server 615, and/or database 618. For example, computing environment 600 may include a network 610. In one or more arrangements, client devices (601 and/or 602), server 615, and/or the other systems included in computing environment 600 may be any type of computing device capable of receiving input via the user interface, and communicating the received input to one or more other computing devices. For example, client devices, server 615, and/or the other systems included in computing environment 600 may in some instances, be and/or include server computers, desktop computers, laptop computers, tablet computers, smartphones, or the like that may include one or more processors, memories, communication interfaces, storage devices, and/or other components. As noted above, any and/or all of the client devices and/or server 615 may, in some instances, be special-purpose computing devices configured to perform specific functions.

A web browser may be executed on each of the plurality of client devices 601 and/or 602. The web browser may be executed by hardware/software located at the client device or be executed remotely and accessed the client device (e.g., via a remote protocol). The web browser may be configured to obtain data associated with a webpage and/or render content in a webpage format. The rendered webpage may be configured to be displayed via the user interface of the web browser. As described in further detail below, during a virtual meeting, a presenter 606 may access a webpage and/or display the webpage via a first web browser on the client device 601. The server 615 may send data and instructions to web browsers on one or more client devices 602 associated with other participants, so that the content being displayed on the client device 601 may be displayed on the one or more client devices 602 in a webpage format. As described in detail below, the presenter 606's input on the webpage (e.g., pointing/highlighting an area of the webpage by a mouse icon, typing text into a dialog window of the webpage, clicking a button on the webpage) may also be presented to other participants (e.g., non-presenters 607). The presentation may be facilitated by server 615. For example, client device 601 may send, to server 615, data associated with the webpage and/or the presenter's input to the webpage. The server 615 may generate a corresponding read-only webpage corresponding to the original webpage and send the read-only webpage to the client device 602. The client device 602 may render the content of the read-only webpage (e.g., locally), so that the content is displayed in a format of a webpage, instead of an image or video.

Displaying content as a webpage may facilitate the user to view the content at his or her own pace, and/or may facilitate the user to make operations on the webpage. For example, while text might not be copied from an image or a video, text may be copied from the webpage. In another example, the user may be allowed to scroll the webpage up and/or down during the meeting, in order to review content discussed (or preview content to be discussed) by the presenter 606 at another time.

The read-only webpage may comprise restrictions to the user's operations on the original webpage (e.g., restrictions to access a link on the original first webpage). This may allow the presenter 606 to prevent the non-presenters from accessing certain data (e.g., sensitive data) via the original webpage. This may facilitate the presenter 606 to easily present information without worrying about accidentally sharing information that the presenter 606 does not want to share.

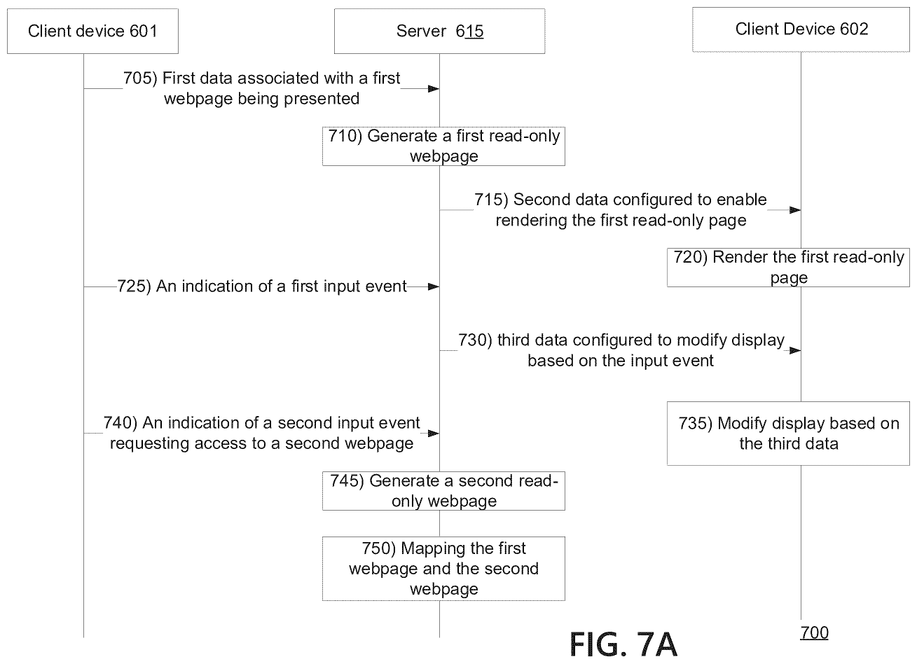

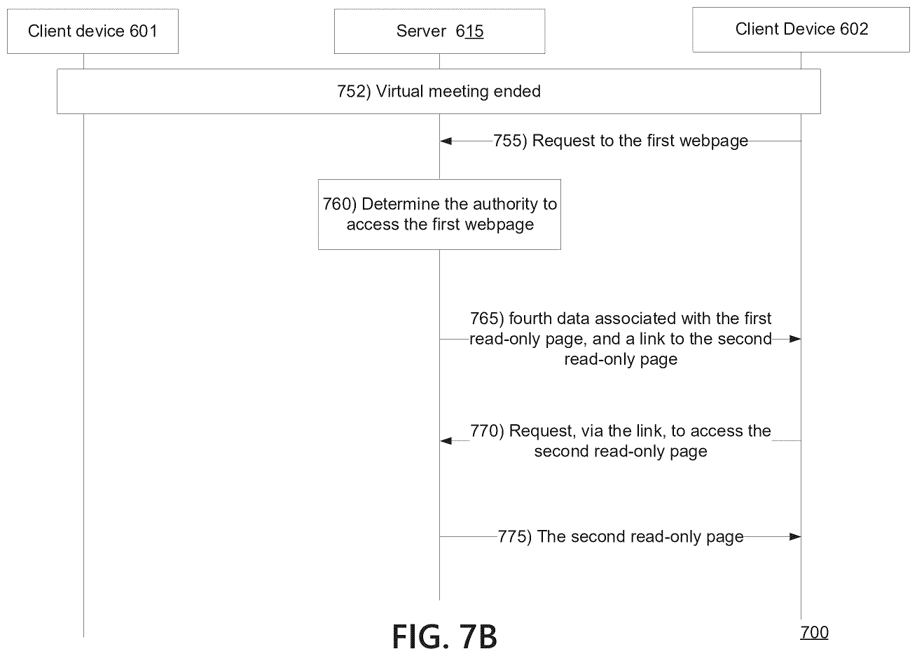

FIGS. 7A to 7B is a sequence diagram depicting an example method of content presentation. The steps of method 700 may be performed by a system comprising a plurality of client devices (e.g., 601 and/or 602) and/or the server 615 as described in connection with FIG. 6. The plurality of client devices may comprise one or more client devices 601 that are associated with one or more presenters 606 in a virtual meeting. The plurality of client devices may also comprise one or more client devices 602 that are associated with one or more non-presenters 607 in the virtual meeting. Alternatively or additionally, some or all of the steps of method 700 may be performed by one or more other computing devices. The steps of method 700 may be modified, omitted, and/or performed in other orders, and/or other steps added.

At step 705, server 615 may receive, from a first web browser associated with a presenter 606 of a virtual meeting, first data associated with a first webpage. The first webpage may be presented in the virtual meeting. The first web browser may be a browser executed on the client device 601. The first data may comprise document object model (DOM) data, cascading style sheets (CSS) data, and/or uniform resource locator (URL) links associated with the source of the first webpage. The first data may also indicate the portion of the first webpage that is currently displayed on the client device 601

At step 710, server 615 may generate, based on the first data, a first read-only webpage comprising content in the first webpage. The server 615 may generate the first read-only webpage by adding one or more JavaScript (JS) commands to the original first webpage. The first read-only webpage may comprise restrictions to the user's operations on the original first webpage. For example, the original first webpage may comprise a link to access a second webpage. The first read-only webpage may restrict the user's accessing, via the link, the second webpage. For example, if a user clicks, via a web browser, the link on the original first webpage, the web browser may obtain the second webpage based on the address (e.g., a URL) indicated by the link and display the second webpage via the web browser. By contrast, if the user clicks on the same link on the first read-only webpage, the web browser may refrain from obtaining and/or displaying the second webpage.

At step 715, the server 615 may send, during the virtual meeting and to a second web browser, second data. The second data may be configured to enable rendering, in the second web browser, the first read-only webpage. For example, the second data may comprise all or a portion of DOM data and/or CSS data in the first data. The second data may comprise the command to restrict the user's operation on the original first webpage. The second data may also comprise instructions to render the first webpage. The second data may also indicate the portion of the first webpage that is currently displayed on the client device 601, and/or instructions to the client device 602 to display the corresponding portion of the first read-only webpage via the client device 602. The first read-only webpage may be rendered in a formality of a webpage, instead of an image or video. The second web browser may be executed on the client device 602 associated with a non-presenter 607 of the virtual meeting. The non-presenter 607 may use the second web browser on the client device 602 to view the content presented during the virtual meeting. In this way, the content in the first webpage is shared between the client device 601 and client device 602.

At step 720, the client device 602 may render (e.g., via the second web browser), based on the second data, the first read-only webpage. The first read-only webpage may be displayed via a user interface of the second web browser. The user of the client device 602 may be able to copy text from the first read-only webpage. At default, the second web browser may display the portion of the first read-only webpage that is corresponding to the portion of the original first webpage that is currently presented by the presenter 606. The user of client device 602 may scroll up and/or down to view another portion of the first read-only webpage.

At step 725, the server may receive, from the client device 601, an indication of an input event that occurs while the first webpage is presented in the virtual meeting. The input event may be made by the presenter 606 associated with client device 601. The input event may comprise a command made to the first web browser. The command may instruct the first web browser to make an operation on the first webpage. For example, the input event may comprise a command to access a link on the first webpage, to zoom in or zoom out a certain area of the first webpage, to type text into a dialog window on the first webpage, or to highlight text displayed on the first webpage. Alternatively or additionally, the input event may comprise a command to move a mouse icon from one position to another.

At step 730, the server 615 may send, during the virtual meeting and to the client device 602, third data. The third data may be associated with the input event. The third data may be configured to modify the display associated with the first read-only webpage, on the client device 602, based on the input event.

The third data may be configured to enable overlaying, on the first read-only webpage displayed by the second web browser, with one or more images representing the input event. For example, if the input event is a mouse clicking on a link on the first webpage, the third data may instruct overlaying a mouse icon on the displayed first read-only webpage. The movement of the mouse icon that is overlayed on the first read-only webpage may correspond to the movement of the mouse icon that is displayed on the original first webpage on the client device 601. The third data may comprise information on the movement of the mouse icon.

Additionally or alternatively, the third data may be configured to instruct displaying the content on the first read-only webpage based on the input event. For example, if the input event comprises a command to zoom in a certain area on the original first webpage, the third data may instruct the second web browser to zoom in the corresponding area of the first read-only webpage. In another example, if the input event comprises a command to scroll down to a certain area of the original first webpage on the first web browser, the third data may instruct the second web browser to scroll down to the corresponding area of the first read-only webpage.

At step 735, the client device 602 may (e.g., via the second web browser) modify the display based on the third data. The user of the client device 602 may be provided options (e.g., via an interactive menu) in terms of whether to modify the display or not, and/or when to modify the display. For example, if the user wants to follow presenter 606's operation on the original first webpage, the user may allow modifying the display after the third data is received. If the user wants to take some time to read the content of the first read-only webpage by herself, the user may decline to modify the display and/or postpone the modification to a later time (e.g., after the user finishes the reading).

If the client device 601 keeps receiving new input events that comprise commands made to the first web browser, the client device 601 may keep sending indications of the newly received input events to server 615. The server 615 may generate and/or send new data (e.g., similar to the third data as described above) configured to modify the display of the second web browser on the client device 602. The client device 602 may modify, based on the new data, the display of the first read-only webpage similar to as described above.

At step 740, the server 615 may receive, from the client device 601, an indication of a second input event requesting access to a second webpage. The second input event may be made to the first web browser on the client device 601 while the first webpage is presented during the virtual meeting. The request to access the second webpage may be made via the first webpage. For example, presenter 606 may click a link on the original first webpage. The link may be a link to access the second webpage. The client device 601 may obtain the second webpage from its source and display the content of the second webpage via the first web browser. The client device 601 may send, to the server 615, data associated with the second webpage and/or the link on the first webpage. The data associated with the second webpage may be of similar types as the first data described in step 705.

At step 745, the server 615 may generate, based on the data associated with the second webpage, a second read-only webpage. The second read-only webpage may comprise content displayed in the second webpage. The server 615 may generate the second read-only webpage in a way similar to that discussed in step 710. The second read-only webpage may be sent from the server 615 to one or more client devices 602. The one or more client devices 602 may render the second read-only webpage and/or modify the display of the second read-only webpage based on additional input events, in a way similar to described in steps 720 to 735.

At step 750, the server 615 may store, in a database (e.g., database 618 as described in connection with FIG. 6), a mapping among the first webpage (either an original version or a read-only version), the second input event, and the second webpage (either an original version or a read-only version). The mapping may be used by the server 615 after the virtual meeting ends. The mapping may facilitate the server 615 to allow participants of the virtual meeting to review the webpages presented by the presenter(s) of the virtual meeting, as described in connection with FIG. 7B below.

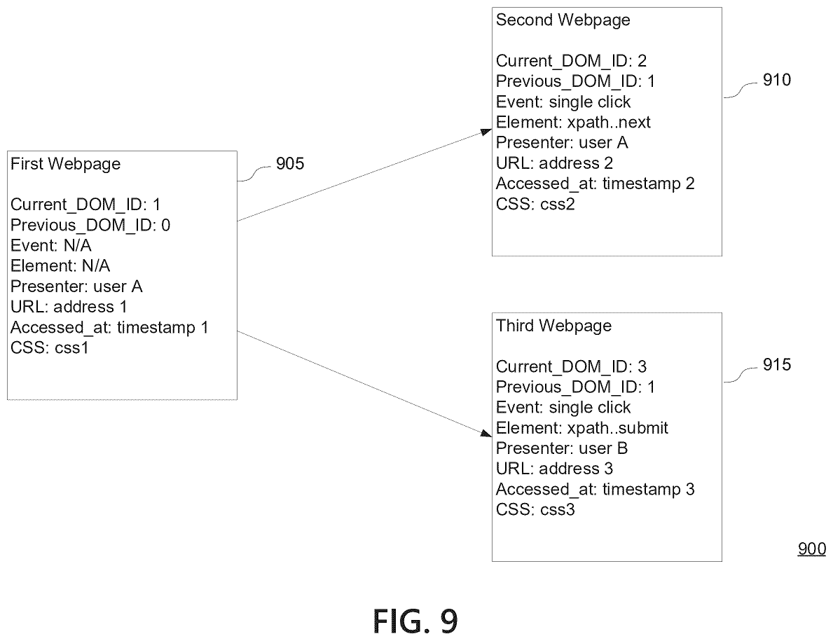

FIG. 9 depicts an example data structure of the mapping. Referring to FIG. 9, three record nodes (e.g., record nodes 905, 910, and 915) may be stored in a record table 900. Each of the record nodes may comprise information associated with a webpage that is presented during the virtual meeting. As shown in FIG. 9, record node 905 may be associated with the first webpage. The record node 905 may indicate “Current_DOM_ID” is “1,” which may indicate the DOM ID of the first webpage is 1. The record 905 may indicate “Previous_DOM_ID” is “0,” and “Event” and “Element” as “N/A,” which may indicate the first webpage is not accessed by the client device 601 via another webpage. For example, presenter 606 may, during the virtual meeting, have typed the address of the first webpage into the address bar in the web browser to access the first webpage. The record 905 may indicate the “Presenter” is “user A,” which may indicate that the first webpage is presented by user A during the virtual meeting. The record 905 may also indicate other information associated with the first webpage, such as the URL, the time when the first webpage is accessed by the client device 601 during the virtual meeting, or the CSS of the first webpage.

The record node 910 may be associated with the second webpage. The record node 910 may indicate “Current_DOM_ID” is “2,” which may indicate the DOM ID of the second webpage is 2. The record 910 may indicate “Previous_DOM_ID” is “1,” which may indicate the second webpage was accessed by the client device 601 during the virtual meeting via another webpage that has a DOM ID of 1 (e.g., the first webpage). The record 910 may indicate “Event” as a “single click,” which may indicate the second webpage is accessed via the first webpage by a single click (e.g, of a mouse) on a link in the first webpage. The record 910 may indicate “Element” as “xpath . . . next,” which may indicate the single click is made on a “next” element defined by an extensible markup language (XML) path. Consistent with FIG. 7A, the single click may be the second input event as described in step 740. The record 910 may indicate the “Presenter” is “user A,” which may indicate that the second webpage is presented by user A during the virtual meeting. The record node 910 may also indicate other information associated with the second webpage, such as the URL, the time when the second webpage is accessed by the client device 601 during the virtual meeting, or the CSS of the second webpage.

Similarly, during the virtual meeting, a third webpage may be accessed via the first webpage at another time. The record node 915 may be associated with the third webpage. The record node 915 may indicate “Current_DOM_ID” is “3,” which may indicate the DOM ID of the third webpage is 3. The record 915 may indicate “Previous_DOM_ID” is “1,” which may indicate the third webpage is accessed by the client device 601 during the virtual meeting via another webpage that has a DOM ID of 1 (e.g., the first webpage). The record 915 may indicate “Event” as a “single click,” which may indicate the third webpage is accessed via the first webpage by a single click (e.g, of a mouse) on a link of the first webpage. The record 915 may indicate “Element” as “xpath . . . submit,” which may indicate the single click is made on a “submit” element defined by XML path. The record node 915 may indicate the “Presenter” is “user B,” which may indicate that the third webpage is presented by user B during the virtual meeting. The record 915 may also indicate other information associated with the third webpage, such as the URL, the time when the third webpage is accessed by the client device 601 during the virtual meeting, or the CSS of the third webpage.

It is appreciated that information in each of the record nodes and/or the record table are merely examples. For example, the record table may comprise more record nodes or fewer record nodes than shown in FIG. 9. Each record node may comprise information that is different from FIG. 9.

Referring back to FIG. 7B, at step 752, the virtual meeting may be ended. The presenter 606 may stop presenting content via the client device 601. After the virtual meeting, participants (either presenters or non-presenters) may want to review the content of the webpages presented during the meeting. As described in further detail below, a participant may review (e.g., via a web browser that the participant used during the meeting) the content of webpages presented during the meeting.

At step 755, after the virtual meeting, server 615 may receive a request to access the first webpage (or the first read-only webpage corresponding to the first webpage). The request may be received from a client device 602 that is associated with a non-presenter 607. The client device 602 depicts in FIG. 7B may be the same client device as described in FIG. 7A. The client device 602 may be a client device that is different from the client device 602 described in FIG. 7A. For example, the client device 602 in FIG. 7A may be the client device 602a that is associated with non-presenter 607a, while the client device 602 in FIG. 7B may be the client device 602n that is associated with non-presenter 607n, as shown in FIG. 6.

The web browsers used by presenter 606 and non-presenter 607 may each store a browser history comprising information associated with webpages being presented during the virtual meeting. The client device 602 may obtain a link to the first webpage from the browser history. The link may indicate an address of the first webpage in the server 615 (or a database 618 that communicates with the server 615), instead of the address of the original first webpage from its original source. If the user of client device 602 clicks the link, the client device 602 may obtain the first webpage from the server 615, instead of the original source of the original first webpage.

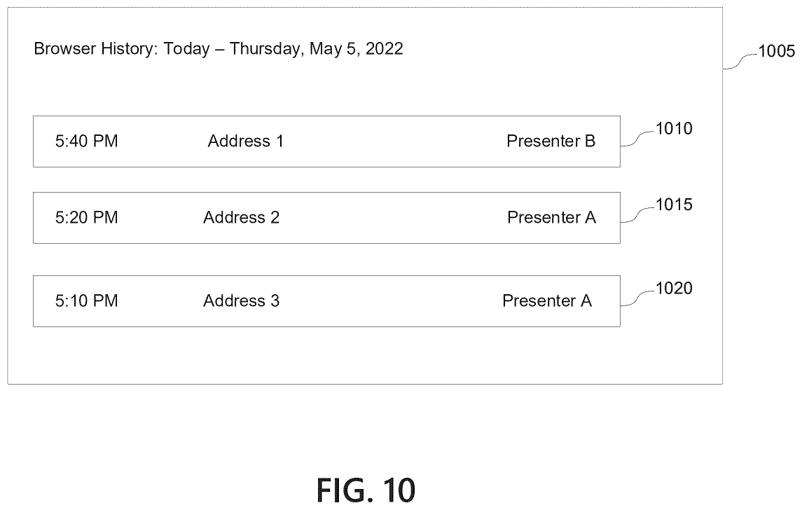

FIG. 10 depicts a user interface 1005 displaying the browser history. Referring to FIG. 10, the user interface 1005 may display the browser history of a time period (e.g., Thursday, May 5, 2022, as shown in FIG. 10). The user interface 1005 may comprise three records (e.g., record 1010, 1015, and 1020). The three records may indicate webpages presented during a virtual meeting held (e.g., from 5 PM to 6 PM on May 5, 2022). Record 1010 may indicate that, at time 5:40 PM, a webpage addressed to “Address 1” is presented by presenter B. Record 1015 may indicate that, at time 5:20 PM, a webpage addressed to “Address 2” is presented by presenter A. Record 1020 may indicate that, at time 5:10 PM, a webpage addressed to “Address 3” is presented by present A. Consistent with the example described in FIGS. 7A and 7B, the webpage that is addressed to “Address 3” may be the first webpage, and/or the webpage that is addressed to “Address 2” may be the second webpage. The user of a client device (client device 601 or client device 602) may use the address indicated in a record to access the corresponding webpage.

Referring back to FIG. 7B, at step 760, server 615 may determine whether the user associated with the client device 602 has the authority to access the original first webpage or not. If the original first webpage is allowed to be accessed by the public (e.g., a Wikipedia webpage), the server 615 may determine that the user has the authority to access the original first webpage. If the access to the original first webpage is limited to a certain group of users, account information (e.g., user identifier and/or user credential) may be used to determine the user's authority. For example, if the first webpage is a webpage of a database that can only be accessed by its members (e.g., after logging in to a user portal), server 615 may request, from the client device 602, the login information. While a presenter 606 may have the authority to access the original first webpage, a non-presenter 607 may or may not have the authority. The user of the client device 602 may send, to the server 615, the user account information associated with the user of the client device 602. The server 615 may authenticate the user account information (e.g., from the source of the original first webpage). For example, if the user of the client device 602 has the same type of membership as the presenter 606 does, the server 615 may determine that the user of the client device 602 has the authority to access the original first webpage. If the server 615 determines that the user has authority to access the original first webpage, the server 615 may send the original address to the client device 602, so that the client device 602 may obtain the original first webpage from its original source. If the server 615 determines that the user does not has authority to access the original first webpage, the server 615 may perform step 765.

At step 765, the server 615 may send, to the client device 602, fourth data associated with the first read-only webpage. The fourth data may be similar to the second data as described in step 715. The first read-only webpage associated with the fourth data may be modified. The modified first read-only webpage may still restrict the operations on the original first webpage if the operations were not performed by the presenter 606 while the presenter 606 presented the original first webpage during the virtual meeting. The modified first read-only webpage may allow operations on the original first webpage if the operations were performed by the presenter 606 while the presenter 606 presented the original first webpage during the virtual meeting. This may be helpful to allow the user, while reviewing content presented during the virtual meeting, to have a similar experience as if in the virtual meeting. For example, as described above, during the virtual meeting, the presenter 606 may have presented the second webpage and the second webpage may have been accessed via the first webpage. Accordingly, the first read-only webpage may be modified to allow the client device 602 to access the second webpage (either the original or read-only version, based on whether the user of the client device 602 has the authority to access the original second webpage) via the first read-only webpage. For example, the modified first read-only webpage may comprise a link to a second webpage (either the original or read-only version).

At step 770, the server 615 may receive, from the client device 602, a request, via the link, to access the second webpage. For example, the request may be made by a mouse clicking an area, on the modified first read-only webpage, that is associated with the link.

At step 775, the server 615 may send, to the client device 602, the second webpage. Based on whether the user of the client device 602 has the authority to access the original second webpage or not, the server 615 may send either the second ready-only page or the original second webpage (or a link to obtain the original second webpage from its source).

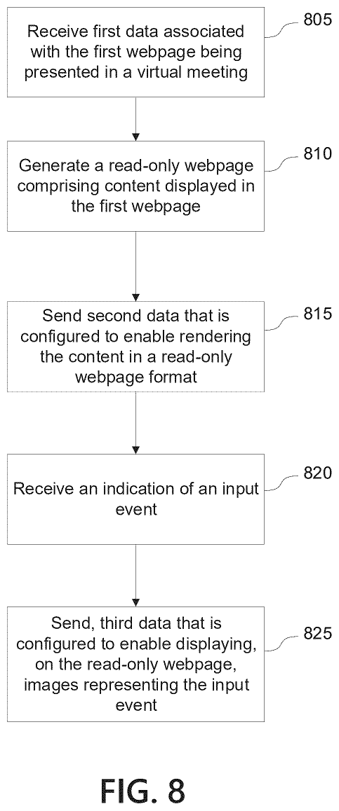

FIG. 8 depicts a flow chart depicting content presentation as described herein. The steps of method 800 may be performed by a system comprising a plurality of client devices and server 615 as described in connection with FIG. 6. The plurality of client devices may comprise one or more client devices 601 that are associated with one or more presenters in a virtual meeting. The plurality of client devices may also comprise one or more client devices 602 that are associated with one or more non-presenters in the virtual meeting. The plurality of client devices and the server 615 may perform the content presentation as described in connection with FIGS. 7A and 7B. Alternatively or additionally, some or all of the steps of method 700 may be performed by one or more other computing devices. The steps of method 800 may be modified, omitted, and/or performed in other orders, and/or other steps added.

At step 805, the server 615 may receive, from a first client device, first data associated with a first webpage being displayed in a first web browser on the first client device 601. Step 801 may be performed similarly as described in step 705.

At step 810, the server 615 may generate, based on the first data, a read-only webpage corresponding to (e.g., comprising content displayed in) the first webpage. Step 810 may be performed similarly as described in step 710.

At step 815, the server 615 may send, to a second client device 602 while the first webpage is displayed in the first web browser, second data that is configured to enable rendering, in a second web browser on the second client device 602, the read-only webpage, so that content in the first webpage is shared between the first client device 601 and the second client device 602. Step 815 may be performed similarly as described in step 715.

At step 820, the server 615 may receive, from the first client device 601, an indication of an input event on the first web browser. The input event may occur while the first webpage is shared during the virtual meeting. Step 820 may be performed similarly as described in step 725.

At step 825, the server 615 may send, during the virtual meeting and to the second web browser, third data, associated with the input event. The server 615 may be configured to enable displaying, in the second web browser, one or more images representing the input event. Step 825 may be performed similarly as described in step 735.

The following paragraphs (M1) through (M8) describe examples of methods that may be implemented in accordance with the present disclosure.

(M1) A method comprising: receiving, by a server and from a first client device, first data associated with a first webpage being displayed in a first web browser on the first client device; generating, by the server and based on the first data, a read-only webpage corresponding to the first webpage; sending, by the server, to a second client device, and while the first webpage is displayed in the first web browser, second data that is configured to enable rendering, in a second web browser on the second client device, the read-only webpage, so that content in the first webpage is shared between the first client device and the second client device; receiving, by the server and from the first client device, an indication of an input event, on the first web browser, that occurs while the content in the first webpage is shared; and sending, by the server to the second client device, third data associated with the input event, wherein the third data is configured to enable displaying, in the second web browser, one or more images representing the input event.

(M2) A method may be performed as described in paragraph (M1) wherein the first webpage comprises a link to access a second webpage, and wherein the read-only webpage restricts accessing, via the link, the second webpage.

(M3) A method may be performed as described in any of paragraphs (M1) through (M2) wherein the sending the second data is based on a determination that a user associated with the second web browser does not have authority to access the first webpage.

(M4) A method may be performed as described in any of paragraphs (M1) through (M3) wherein the input event comprises a request to access a second webpage, and wherein the method further comprises: receiving, from the first client device, fourth data associated with the second webpage; generating a second read-only webpage corresponding to the second webpage; and storing, in a database, a mapping among the read-only webpage, the input event, and the second read-only webpage.

(M5) A method may be performed as described in any of paragraphs (M1) through (M4), further comprising: receiving, from a third client device and after the content in the first webpage is shared, a request to access the content; sending, to the third client device, the second data associated with the read-only webpage and a link to the second read-only webpage; receiving, from the third client device, a request to access, via the link, the second read-only webpage; and sending, to the third client device, the second read-only webpage.

(M6) A method may be performed as described in any of paragraphs (M1) through (M5) wherein the first data comprises at least one of: document object model (DOM) data; cascading style sheets (CSS) data; or a uniform resource locator (URL) link.

(M7) A method may be performed as described in any of paragraphs (M1) through (M6) wherein generating the read-only webpage comprising adding JavaScript (JS) data into the first data.

(M8) A method may be performed as described in any of paragraphs (M1) through (M7) wherein the server and the first client device are located on the same physical device.

The following paragraphs (A1) through (A6) describe examples of apparatus that may be implemented in accordance with the present disclosure.

(A1) An apparatus, comprising: one or more processors; and memory storing instructions that, when executed by the one or more processors, cause the apparatus to: receive, from a first client device, first data associated with a first webpage being displayed in a first web browser on the first client device; generate, based on the first data, a first read-only webpage corresponding to the first webpage; send, to a second client device while the first webpage is displayed in the first web browser, second data that is configured to enable rendering, in a second web browser on the second client device, the read-only webpage, so that content in the first webpage is shared between the first client device and the second client device; receive, from the first client device, an indication of an input event, on the first web browser, that occurs while the content in the first webpage is shared; and send, to the second client device, third data associated with the input event, wherein the third data is configured to display, in the second web browser, one or more images representing the input event.

(A2) An apparatus may be performed as described in paragraph (A1) wherein the first webpage comprises a link to access a second webpage, and wherein the first read-only webpage restricts accessing, via the link, the second webpage.

(A3) An apparatus may be performed as described in any of paragraphs (A1) through (A2) wherein the instructions, when executed by the one or more processors, cause the apparatus to send the second data based on a determination that a user associated with the second web browser does not have authority to access the first webpage.

(A4) An apparatus may be performed as described in any of paragraphs (A1) through (A3) wherein the input event comprises a request to access a second webpage, and wherein the instructions, when executed by the one or more processors, further cause the apparatus to: receive, from the first client device, fourth data associated with the second webpage; generate a second read-only webpage corresponding to the second webpage; and store, in a database, a mapping among the first read-only webpage, the input event, and the second read-only webpage.

(A5) An apparatus may be performed as described in any of paragraphs (A1) through (A4) wherein the instructions, when executed by the one or more processors, further cause the apparatus to: receive, from a third client device and after the content in the first webpage is shared, a request to access the content; send, to the third client device, the second data associated with the first read-only webpage and a link to the second read-only webpage; receive, from the third client device, a request to access, via the link, the second read-only webpage; and send, to the third client device, the second read-only webpage.

(A6) An apparatus may be performed as described in any of paragraphs (A1) through (A5) wherein the apparatus and the first client device are located on the same physical device.

The following paragraphs (CRM1) through (CRM5) describe examples of computer-readable media that may be implemented in accordance with the present disclosure.

(CRM1) A non-transitory computer-readable medium storing computer instruction that, when executed by one or more processors of a computing device, cause performance of actions comprising: receiving, from a first client device, first data associated with a first webpage being displayed in a first web browser on the first client device; generating, based on the first data, a first read-only webpage comprising corresponding to the first webpage; sending, to a second client device while the first webpage is displayed in the first web browser, second data that is configured to enable rendering, in a second web browser on the second client device, the read-only webpage, so that content in the first webpage is shared between the first client device and the second client device; receiving, from the first client device, an indication of an input event, on the first web browser, that occurs while the content in the first webpage is shared; and sending, to the second client device, third data associated with the input event, wherein the third data is configured to enable displaying, in the second web browser, one or more images representing the input event.

(CRM2) A non-transitory computer-readable medium may be performed as described in paragraph (CRM1) wherein the first webpage comprises a link to access a second webpage, and wherein the first read-only webpage restricts accessing, via the link, the second webpage.

(CRM3) A non-transitory computer-readable medium may be performed as described in any of paragraphs (CRM1) through (CRM2), wherein the instructions, when executed by the one or more processors, cause the computing device to send the second data based on a determination that a user associated with the second web browser does not have authority to access the first webpage.

(CRM4) A non-transitory computer-readable medium may be performed as described in any of paragraphs (CRM1) through (CRM3), wherein the input event comprises a request to access a second webpage, and wherein the instructions, when executed by the one or more processors, further cause the computing device to: receive, from the first client device, fourth data associated with the second webpage; generate a second read-only webpage corresponding to the second webpage; and store, in a database, a mapping among the first read-only webpage, the input event, and the second read-only webpage.

(CRM5) A non-transitory computer-readable medium may be performed as described in any of paragraphs (CRM1) through (CRM4), wherein the instructions, when executed by the one or more processors, further cause the computing device to: receive, from a third client device and after the content in the first webpage is shared, a request to access the content; send, to the third client device, the second data associated with the first read-only webpage and a link to the second read-only webpage; receive, from the third client device, a request to access, via the link, the second read-only webpage; and send, to the third client device, the second read-only webpage.

(CRM6) A non-transitory computer-readable medium may be performed as described in any of paragraphs (CRM1) through (CRM5), wherein the first data comprises at least one of: document object model (DOM) data; cascading style sheets (CSS) data; or a uniform resource locator (URL) link.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a server and from a first client device, first data associated with a first webpage being displayed in a first web browser on the first client device;
generating, by the server and based on the first data, a read-only webpage corresponding to the first webpage;
sending, by the server, to a second client device, and while the first webpage is displayed in the first web browser, second data that is configured to enable rendering, in a second web browser on the second client device, the read-only webpage, so that content in the first webpage is shared between the first client device and the second client device;
receiving, by the server and from the first client device, an indication of an input event, on the first web browser, that occurs while the content in the first webpage is shared; and
sending, by the server to the second client device, third data associated with the input event, wherein the third data is configured to enable displaying, in the second web browser, one or more images representing the input event.

2. The method of claim 1, wherein the first webpage comprises a link to access a second webpage, and wherein the read-only webpage restricts accessing, via the link, the second webpage.

3. The method of claim 1, wherein the sending the second data is based on a determination that a user associated with the second web browser does not have authority to access the first webpage.

4. The method of claim 1, wherein the input event comprises a request to access a second webpage, and wherein the method further comprises:
receiving, from the first client device, fourth data associated with the second webpage;
generating a second read-only webpage corresponding to the second webpage; and
storing, in a database, a mapping among the read-only webpage, the input event, and the second read-only webpage.

5. The method of claim 4, further comprising:
receiving, from a third client device and after the content in the first webpage is shared, a request to access the content;
sending, to the third client device, the second data associated with the read-only webpage and a link to the second read-only webpage;
receiving, from the third client device, a request to access, via the link, the second read-only webpage; and
sending, to the third client device, the second read-only webpage.

6. The method of claim 1, wherein the first data comprises at least one of:
document object model (DOM) data;
cascading style sheets (CSS) data; or
a uniform resource locator (URL) link.

7. The method of claim 1, wherein generating the read-only webpage comprising adding JavaScript (JS) data into the first data.

8. The method of claim 1, wherein the server and the first client device are located on the same physical device.

9. An apparatus, comprising:
one or more processors; and
memory storing instructions that, when executed by the one or more processors, cause the apparatus to:
receive, from a first client device, first data associated with a first webpage being displayed in a first web browser on the first client device;
generate, based on the first data, a first read-only webpage corresponding to the first webpage;
send, to a second client device while the first webpage is displayed in the first web browser, second data that is configured to enable rendering, in a second web browser on the second client device, the read-only webpage, so that content in the first webpage is shared between the first client device and the second client device;
receive, from the first client device, an indication of an input event, on the first web browser, that occurs while the content in the first webpage is shared;
and
send, to the second client device, third data associated with the input event, wherein the third data is configured to display, in the second web browser, one or more images representing the input event.

10. The apparatus of claim 9, wherein the first webpage comprises a link to access a second webpage, and wherein the first read-only webpage restricts accessing, via the link, the second webpage.

11. The apparatus of claim 9, wherein the instructions, when executed by the one or more processors, cause the apparatus to send the second data based on a determination that a user associated with the second web browser does not have authority to access the first webpage.

12. The apparatus of claim 9, wherein the input event comprises a request to access a second webpage, and wherein the instructions, when executed by the one or more processors, further cause the apparatus to:
receive, from the first client device, fourth data associated with the second webpage;
generate a second read-only webpage corresponding to the second webpage; and
store, in a database, a mapping among the first read-only webpage, the input event, and the second read-only webpage.

13. The apparatus of claim 12, wherein the instructions, when executed by the one or more processors, further cause the apparatus to:
receive, from a third client device and after the content in the first webpage is shared, a request to access the content;
send, to the third client device, the second data associated with the first read-only webpage and a link to the second read-only webpage;
receive, from the third client device, a request to access, via the link, the second read-only webpage; and
send, to the third client device, the second read-only webpage.

14. The apparatus of claim 9, wherein the apparatus and the first client device are located on the same physical device.

15. A non-transitory computer-readable medium storing computer instruction that, when executed by one or more processors of a computing device, cause performance of actions comprising:
receiving, from a first client device, first data associated with a first webpage being displayed in a first web browser on the first client device;
generating, based on the first data, a first read-only webpage comprising corresponding to the first webpage;
sending, to a second client device while the first webpage is displayed in the first web browser, second data that is configured to enable rendering, in a second web browser on the second client device, the read-only webpage, so that content in the first webpage is shared between the first client device and the second client device;
receiving, from the first client device, an indication of an input event, on the first web browser, that occurs while the content in the first webpage is shared; and
sending, to the second client device, third data associated with the input event, wherein the third data is configured to enable displaying, in the second web browser, one or more images representing the input event.

16. The non-transitory computer-readable medium of claim 15, wherein the first webpage comprises a link to access a second webpage, and wherein the first read-only webpage restricts accessing, via the link, the second webpage.

17. The non-transitory computer-readable medium of claim 15, wherein the instructions, when executed by the one or more processors, cause the computing device to send the second data based on a determination that a user associated with the second web browser does not have authority to access the first webpage.

18. The non-transitory computer-readable medium of claim 15, wherein the input event comprises a request to access a second webpage, and wherein the instructions, when executed by the one or more processors, further cause the computing device to:
receive, from the first client device, fourth data associated with the second webpage;
generate a second read-only webpage corresponding to the second webpage; and
store, in a database, a mapping among the first read-only webpage, the input event, and the second read-only webpage.

19. The non-transitory computer-readable medium of claim 18, wherein the instructions, when executed by the one or more processors, further cause the computing device to:
receive, from a third client device and after the content in the first webpage is shared, a request to access the content;
send, to the third client device, the second data associated with the first read-only webpage and a link to the second read-only webpage;
receive, from the third client device, a request to access, via the link, the second read-only webpage; and
send, to the third client device, the second read-only webpage.

20. The non-transitory computer-readable medium of claim 15, wherein the first data comprises at least one of:
document object model (DOM) data;
cascading style sheets (CSS) data; or
a uniform resource locator (URL) link.
